(19) United States
(12) Patent Application Publication
(10) Pub. No.: US 2022/0159163 A1
(43) Pub. Date: May 19, 2022

(54) IMAGE PICKUP DEVICE, SOLID-STATE IMAGE PICKUP ELEMENT, CAMERA MODULE, DRIVE CONTROL UNIT, AND IMAGE PICKUP METHOD

(71) Applicant: SONY SEMICONDUCTOR SOLUTIONS CORPORATION, KANAGAWA (JP)

(72) Inventor: SOICHI KUWAHARA, TOKYO (JP)

(21) Appl. No.: 17/310,966

(22) PCT Filed: Feb. 28, 2020
(86) PCT No.: PCT/JP2020/008243

§ 371 Date: Sep. 2, 2021

(30) Foreign Application Priority Data
Mar. 15, 2019 (JP) 2019-048840

(51) Int. Cl. H04N 5/232

(52) U.S. Cl. CPC H04N 5/2328; H04N 5/2254; H04N 5/23212

(57) ABSTRACT

The present disclosure relates to an image pickup device, a solid-state image pickup element, a camera module, a drive control unit, and an image pickup method that enable reliable correction of an influence of movement on an image. The drive control unit finds the movement amount in the process of relatively moving at least one of the optical system and the image pickup unit on the basis of the physically detected movement of the image pickup unit that captures an image of an object via the optical system that collects light from the object and performing optical correction of blur appearing on an image captured by the image pickup unit, and controls drive of at least one of the optical system and the image pickup unit. The signal processing unit performs signal processing of correcting the influence of the movement of the image pickup unit on the image according to a function that converts a position using the position information, the movement information, and the optical axis direction position information synchronized for each coordinate on an image on the basis of the optical axis direction position information, the movement information, and the optical axis direction position information. The present technology can be applied to, for example, a stacked CMOS image sensor.

### TECHNICAL FIELD

The present disclosure relates to an image pickup device, a solid-state image pickup element, a camera module, a drive control unit, and an image pickup method, and particularly to an image pickup device, a solid-state image pickup element, a camera module, a drive control unit, and an image pickup method that enable reliable correction of an influence of movement on an image.

### BACKGROUND ART

Conventionally, optical camera shake correction (OIS: Optical Image Stabilizer) or electronic camera shake correction (EIS: Electronic Image Stabilization) has been used as a technique for correcting camera shake in an image pickup device. In the optical camera shake correction, the blur can be corrected by relatively moving a lens or an image pickup element in parallel according to the amount of blur and shifting the position of the image on the image pickup element. In the electronic camera shake correction, an image captured by the image pickup element is cut out to be an output image, and the blur can be corrected by shifting the cutout position according to the amount of blur.

For example, camera shake includes blur due to rotational movement of the image pickup element and blur due to parallel movement of the image pickup element, and in particular, it has been important to stop blur due to rotational movement of the image pickup element, since the influence of parallel movement of the image pickup element becomes smaller with an increase in the distance to the object. The optical camera shake correction technology has had a problem that the periphery is deformed, since this rotational movement is corrected by parallel movement of the lens or the image pickup element. Similarly, the electronic camera shake correction also has had a problem that the periphery is deformed, since the correction is to move the cutout position in parallel.

Furthermore, no measure has been taken for deformation (focal plane phenomenon) caused by the difference in the movement amount in one screen due to the deviation in exposure time for each pixel line that occurs in an image pickup element that uses a rolling shutter such as a complementary metal oxide semiconductor (CMOS) image sensor.

Accordingly, as disclosed in Patent Document 1, an image pickup device that can perform camera shake correction in response to the difference in the movement amount due to the position on the image plane or the difference in the movement amount due to the deviation in the exposure time in one screen has been proposed. By employing this camera shake correction, it is possible to correct the camera shake from the center to the periphery with extremely high accuracy, and also to correct the deformation due to the focal plane phenomenon.

Moreover, Patent Document 2 proposes a technique for camera shake correction capable of effectively correcting lens distortion, in addition to the technique disclosed in Patent Document 1.

### CITATION LIST

### Patent Document

Patent Document 1: WO 2014/156731 A
Patent Document 2: WO 2017/014071 A

### SUMMARY OF THE INVENTION

### Problems to be Solved by the Invention

By the way, although a good effect can be obtained by the camera shake correction disclosed in Patent Documents 1 and 2 as described above, it is also required, for example, to suppress the influence of parallel vibration and to further effectively correct the camera shake.

The present disclosure has been made in view of such a situation, and is intended to reliably correct the influence of movement on the image.

### Solutions to Problems

An image pickup device according to an aspect of the present disclosure includes: an image pickup unit configured to capture an image of an object via an optical system that collects light from the object; a drive control unit configured to find a movement amount in a process of relatively moving at least one of the optical system and the image pickup unit and performing optical correction of blur appearing on an image captured by the image pickup unit on the basis of physically detected movement of the image pickup unit and control drive of at least one of the optical system and the image pickup unit; and a signal processing unit configured to perform signal processing for correcting an influence of movement of the image pickup unit on the image according to a function that converts a position using perpendicular plane direction position information, movement information, and optical axis direction position information synchronized for each coordinate on the image on the basis of the perpendicular plane direction position information in which a position of the optical system or the image pickup unit driven under control by the drive control unit is detected and a position of the optical system or the image pickup unit driven in a plane direction perpendicular to an optical axis direction under control by the drive control unit is detected, the movement information representing physically detected movement of the image pickup unit, and the optical axis direction position information indicating a relative position in an optical axis direction between the optical system and the image pickup unit.

A solid-state image pickup element according to an aspect of the present disclosure includes: an image pickup unit configured to capture an image of an object via an optical system that collects light from the object; a drive control unit configured to find a movement amount in a process of relatively moving at least one of the optical system and the image pickup unit and performing optical correction of blur appearing on an image captured by the image pickup unit on the basis of physically detected movement of the image pickup unit and control drive of at least one of the optical system and the image pickup unit; and a logic unit configured to give an output to a signal processing unit that performs signal processing for correcting an influence of movement of the image pickup unit on the image according to a function that converts a position using perpendicular plane direction position information, movement information, and movement amount information synchronized for each coordinate on the image on the basis of the perpendicular plane direction position information in which a position of the optical system or the image pickup unit driven in a plane direction perpendicular to an optical axis under control by the drive control unit is detected, the movement information representing physically detected movement of the image pickup unit, and the optical axis direction position information indicating a relative position in an optical axis direction between the optical system and the image pickup unit.

A camera module according to an aspect of the present disclosure includes: an optical system that collects light from an object; an image pickup unit that captures an image of the object via the optical system; a drive control unit configured to find a movement amount in a process of relatively moving at least one of the optical system and the image pickup unit and performing optical correction of blur appearing on an image captured by the image pickup unit on the basis of physically detected movement of the image pickup unit and control drive of at least one of the optical system and the image pickup unit; and a logic unit configured to supply perpendicular plane direction position information, movement information, and optical axis direction position information, and timing information indicating timing that synchronizes the perpendicular plane direction position information, the movement information, and the optical axis direction position information with a coordinate on the image together with an image captured by the image pickup unit to a signal processing unit that performs signal processing of correcting an influence of movement of the image pickup unit on the image according to a function that converts a position using the perpendicular plane direction position information, the movement information, and the optical axis direction position information synchronized for each coordinate on the image on the basis of the perpendicular plane direction position information in which a position of the optical system or the image pickup unit driven in a plane direction perpendicular to an optical axis direction under control by the drive control unit is detected, the movement information representing physically detected movement of the image pickup unit, and the optical axis direction position information indicating a relative position in an optical axis direction between the optical system and the image pickup unit.

A drive control unit according to an aspect of the present disclosure finds a movement amount in a process of relatively moving at least one of an optical system and an image pickup unit and performing optical correction of blur appearing on an image captured by the image pickup unit on the basis of physically detected movement of the image pickup unit that captures an image of the object via the optical system that collects light from the object, controls drive of at least one of the optical system and the image pickup unit, performs a process of adding perpendicular plane direction position information in which a position of the optical system or the image pickup unit driven in a plane direction perpendicular to an optical axis direction under the control is detected, movement information representing physically detected movement of the image pickup unit, and optical axis direction position information indicating a relative position in an optical axis direction between the optical system and the image pickup unit to an image captured by the image pickup unit, and supplies the perpendicular plane direction position information, the movement information, and the optical axis direction position information to a logic unit configured to give an output to a signal processing unit that performs signal processing of correcting an influence of movement of the image pickup unit on the image according to a function that converts a position using the perpendicular plane direction position information, the movement information, and the optical axis direction position information synchronized for each coordinate on the image on the basis of the perpendicular plane direction position information, the movement information, and the optical axis direction position information.

An image pickup method performed by an image pickup device according to an aspect of the present disclosure includes: finding a movement amount in a process of relatively moving at least one of an optical system and an image pickup unit and performing optical correction of blur appearing on an image captured by the image pickup unit on the basis of physically detected movement of the image pickup unit that captures an image of an object via the optical system that collects light from the object and controlling drive of at least one of the optical system and the image pickup unit; and performing signal processing of correcting an influence of movement of the image pickup unit on the image according to a function that converts a position using perpendicular plane direction position information, movement information, and optical axis direction position information synchronized for each coordinate on the image on the basis of the perpendicular plane direction position information in which a position of the optical system or the image pickup unit driven in a plane direction perpendicular to an optical axis direction under the control is detected, the movement information representing physically detected movement of the image pickup unit, and the optical axis direction position information indicating a relative position in an optical axis direction between the optical system and the image pickup unit.

In one aspect of the present disclosure, the movement amount in the process of relatively moving at least one of an optical system and an image pickup unit and optically correcting blur appearing on an image captured by the image pickup unit is found on the basis of physically detected movement of the image pickup unit that captures an image of an object via the optical system that collects light from the object, at least one of the optical system and the image pickup unit is controlled, and signal processing of correcting an influence of movement of the image pickup unit on the image is performed according to a function that converts a position using perpendicular plane direction position information, movement information, and optical axis direction position information synchronized for each coordinate on the image on the basis of the perpendicular plane direction position information in which a position of the optical system or the image pickup unit driven in a plane direction perpendicular to an optical axis direction under the control is detected, the movement information representing physically detected movement of the image pickup unit, and the optical axis direction position information indicating a relative position in an optical axis direction between the optical system and the image pickup unit.

### BRIEF DESCRIPTION OF DRAWINGS

FIG. 1 is a diagram illustrating the direction of camera shake that occurs in an image pickup device.

FIG. 2 is a diagram illustrating the influence of camera shake occurring when rotational vibration occurs.

FIG. 3 is a diagram illustrating the influence of camera shake occurring when shift vibration due to parallel movement is generated.

FIG. 4 is a diagram illustrating the influence of camera shake occurring when shift vibration due to perpendicular movement is generated.

FIG. 5 is a diagram illustrating the relationship between the distance between the lens and the image pickup element and the distance between the point to be imaged and the lens.

FIG. 6 is a diagram illustrating the movement amount due to shift blur.

FIG. 7 is a diagram illustrating the movement amount due to rotational blur.

FIG. 8 is a diagram illustrating correction of a point on an output image.

FIG. 9 is a block diagram showing a configuration example of a first embodiment of an image pickup device to which the present technology is applied.

FIG. 10 is a flowchart illustrating a camera shake correction process.

FIG. 11 is a diagram illustrating vibration in a correctable range in ordinary optical camera shake correction.

FIG. 12 is a diagram illustrating vibration exceeding a correctable range in ordinary optical camera shake correction.

FIG. 13 is a diagram illustrating optical camera shake correction and OIS control information for resetting the correction position.

FIG. 14 is a block diagram showing a configuration example of a second embodiment of an image pickup device to which the present technology is applied.

FIG. 15 is a diagram illustrating OIS control information.

FIG. 16 is a diagram showing a usage example of using an image sensor.

### MODE FOR CARRYING OUT THE INVENTION

Hereinafter, specific embodiments to which the present technology is applied will be described in detail with reference to the drawings.

<Correction for Rotational Blur and Shift Blur>

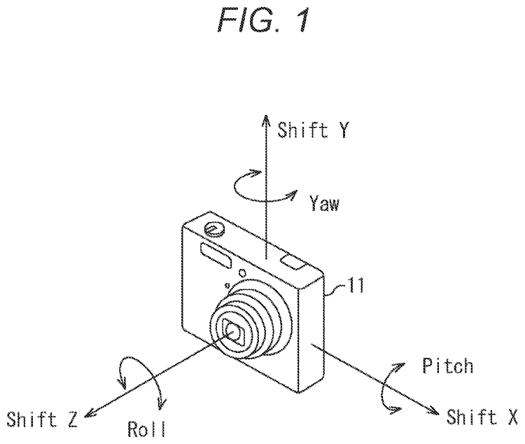

First, the difference in corrections for rotational blur and shift blur will be described with reference to FIGS. 1 to 7.

In the present embodiment, camera shake that occurs in an image pickup device 11 is classified into movements in six directions as shown in FIG. 1.

That is, in the image pickup device 11, camera shake occurs in the pitch direction, yaw direction, and roll direction due to rotational movement, and in the X direction, Y direction, and Z direction due to parallel movement. The X direction is a direction perpendicular to the optical axis direction of the image pickup device 11 and a direction parallel to the lateral direction of the image pickup frame, and the rotation direction about the X direction is the pitch direction. The Y direction is a direction perpendicular to the optical axis direction of the image pickup device 11 and a direction parallel to the vertical direction of the image pickup frame, and the rotation direction about the Y direction is the yaw direction. The Z direction is a direction parallel to the optical axis direction of the image pickup device 11, and the rotation direction about the Z direction is the roll direction. Note that the names of the directions shown in FIG. 1 are not limited to these.

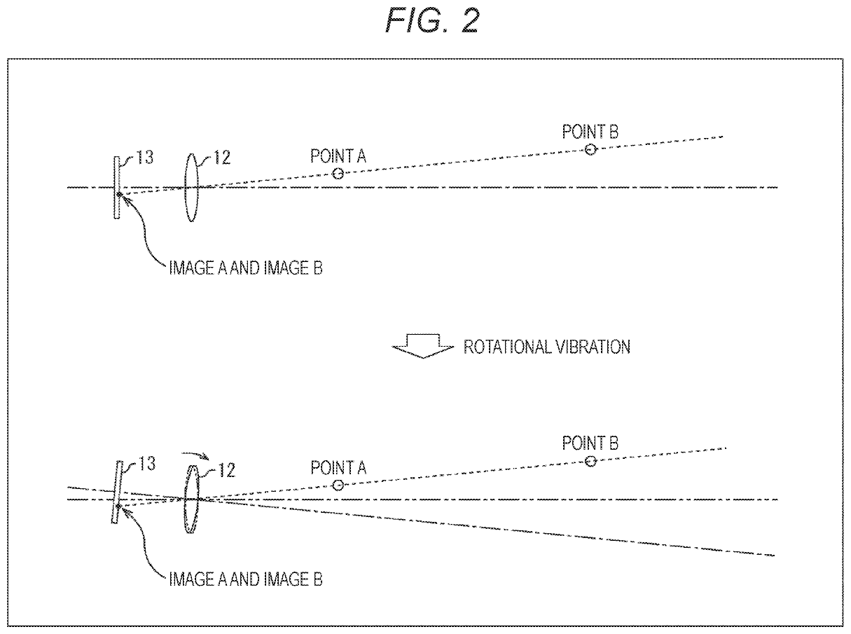

With reference to FIG. 2, the influence of camera shake occurring when the image pickup device 11 rotationally vibrates in the pitch direction or the yaw direction will be described.

FIG. 2 shows how image A and image B on the sensor surface of an image sensor 13 corresponding to two points A and B on an object at a different distance from a lens unit 12 move due to rotational blur occurring when rotational vibration occurs.

In a case where the image A and the image B overlap with each other on the sensor surface of the image sensor 13 as shown in the figure, the image A and the image B move to the same positions on the sensor surface of the image sensor 13 respectively even if rotational blur occurs, and the image A and the image B remain overlapped. That is, in this case, it is shown that the movement amount of the image on the sensor surface of the image sensor 13 does not depend on the distance to the point on the object to be imaged even if rotational blur occurs.

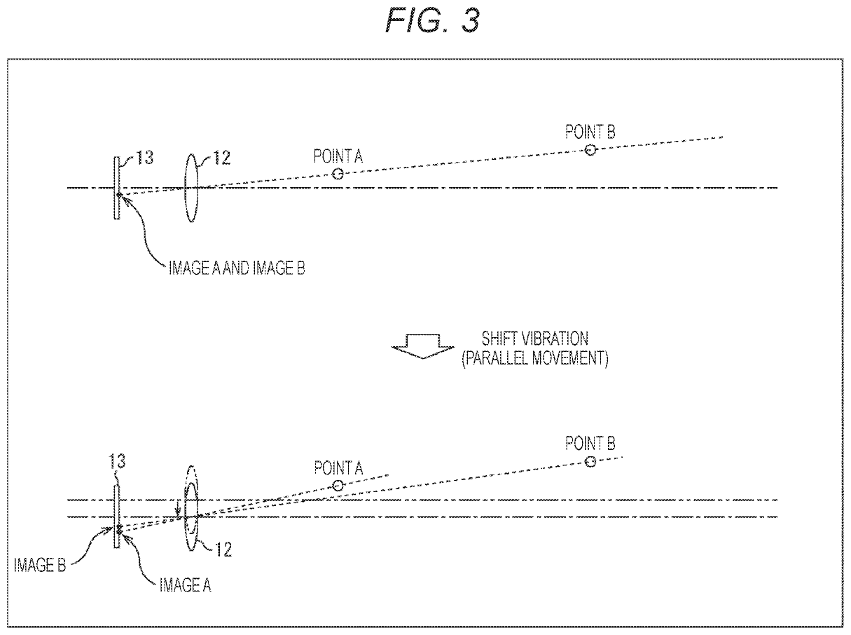

With reference to FIG. 3, the influence of camera shake occurring when the image pickup device 11 shifts and vibrates in the X direction or the Y direction will be described.

FIG. 3 shows how image A and image B on the sensor surface of the image sensor 13, which correspond to two points A and B on an object having different distances from the lens unit 12, move due to shift blur occurring when shift vibration is caused by parallel movement of moving in a direction orthogonal to the optical axis.

In a case where the image A and the image B overlap with each other on the sensor surface of the image sensor 13 as shown in the figure, shift blur occurs, and therefore the image A and the image B move to different positions on the sensor surface of the image sensor 13 and do not overlap. That is, in this case, it is shown that shift blur occurs, and therefore the movement amount of the image on the sensor surface of the image sensor 13 depends on the distance to the point on the object to be imaged, and the movement amount becomes larger as an object to be imaged is closer, or the movement amount becomes smaller as an object to be imaged is farer.

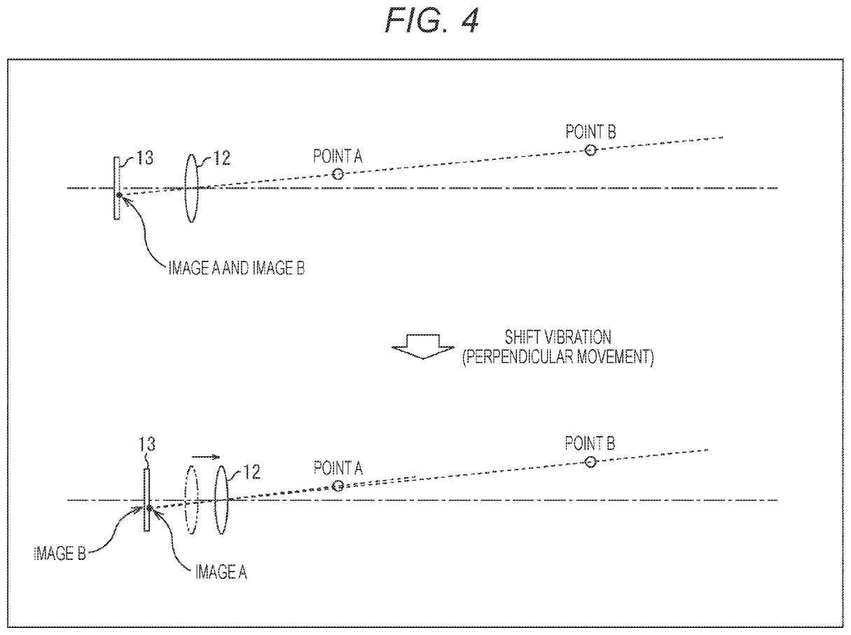

With reference to FIG. 4, the influence of camera shake occurring when the image pickup device 11 shifts and vibrates in the Z direction will be described.

FIG. 4 shows how image A and image B on the sensor surface of the image sensor 13, which correspond to two points A and B on an object having different distances from the lens unit 12, move due to shift blur occurring when shift vibration is caused by perpendicular movement of moving in the optical axis.

In a case where the image A and the image B overlap with each other on the sensor surface of the image sensor 13 as shown in the figure, shift blur occurs, and therefore the image A and the image B move to different positions on the sensor surface of the image sensor 13 except for the points on the optical axis, and do not overlap. That is, in this case, it is shown that shift blur occurs, and therefore the movement amount of the image on the sensor surface of the image sensor 13 depends on the distance to the point on the object to be imaged. Then, in this case, the image is magnified in a case where it is moved closer to the object to be imaged, and is reduced in a case where it is moved away from the object to be imaged. Furthermore, the scaling ratio becomes larger as it is closer to the distance to the object to be imaged, and the scaling ratio becomes smaller as it is farther from the object to be imaged.

As described above, the rotational blur does not depend on the distance to an object to be imaged, and the camera shake can be suppressed by correcting the rotational blur by an amount corresponding to the blur angle. On the other hand, shift blur cannot be corrected correctly unless the distance to the object to be imaged is grasped. Furthermore, since the movement amount differs depending on the distance to the object to be imaged, the shift blur cannot be corrected unless the object distance to be corrected is determined.

By the way, it is generally considered that an object to be desired most to be imaged is in a focused area. Accordingly, by grasping the distance to the in-focus area and performing correction according to the distance, it is possible to correct the camera shake that occurs for the object desired most to be imaged. Of course, in a case where an out-of-focus area is desired to be corrected, it is possible to correct the camera shake occurring in the out-of-focus area by adding the out-of-focus deviation to the calculation in the process of calculating the correction amount.

Furthermore, the lens unit 12 and the image sensor 13 are relatively moved in the present embodiment as described later in order to acquire the distance to an object to be imaged in focus for each image position including the difference in imaging timing and the like. Then, the AF position information is acquired in a time series (several to several tens of times in one frame, or a constant frequency higher than the same), and is sequentially sent to the signal processing unit in the subsequent stage for use in processing. This AF position information is relative position information of the lens unit 12 and the image sensor 13 in the optical axis direction, and can be known from, for example, the value of the Hall element used for controlling the AF actuator, or the like.

For example, when assembling the camera module of the image pickup device 11, the AF position information A_{offset} is acquired in advance by measuring the lens position at the focal length position of the lens unit 12. Then, the distance L (μm) from the lens unit 12 to the image sensor 13 is found as shown in the following expression (1) using the focal length F (μm) of the lens unit 12, the AF position information A to be used when the distance L is desired to be known, the AF position information A_{offset} acquired in advance, and the coefficient C (μm/digit) that converts the AF position information into units of μm.

[Expression 1]

L=F+(A−A_{offset})·C (1)

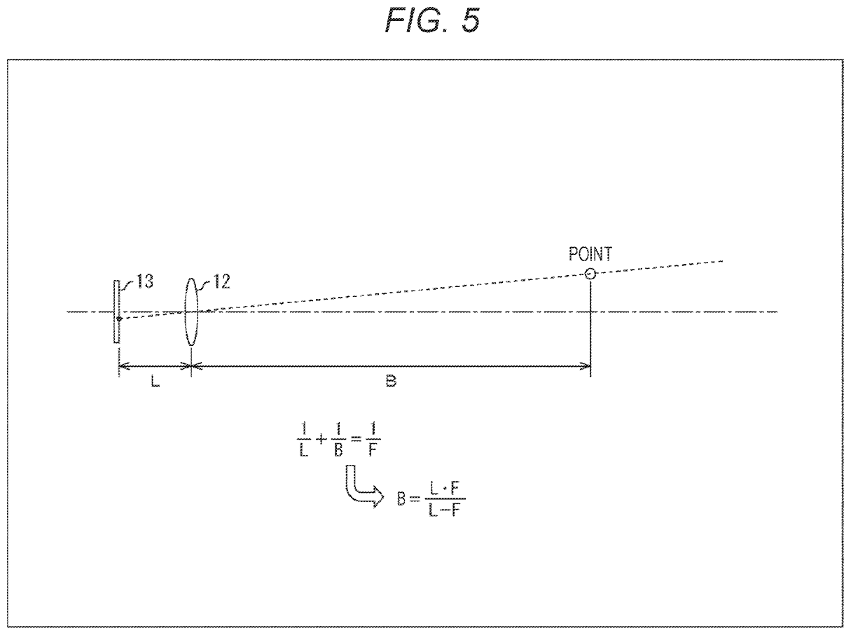

At this time, the distance B (μm) from a point on the object to be imaged in focus to the lens unit 12 can be found by the mathematical expression shown in FIG. 5 using the distance L (μm) and the focal length F (μm).

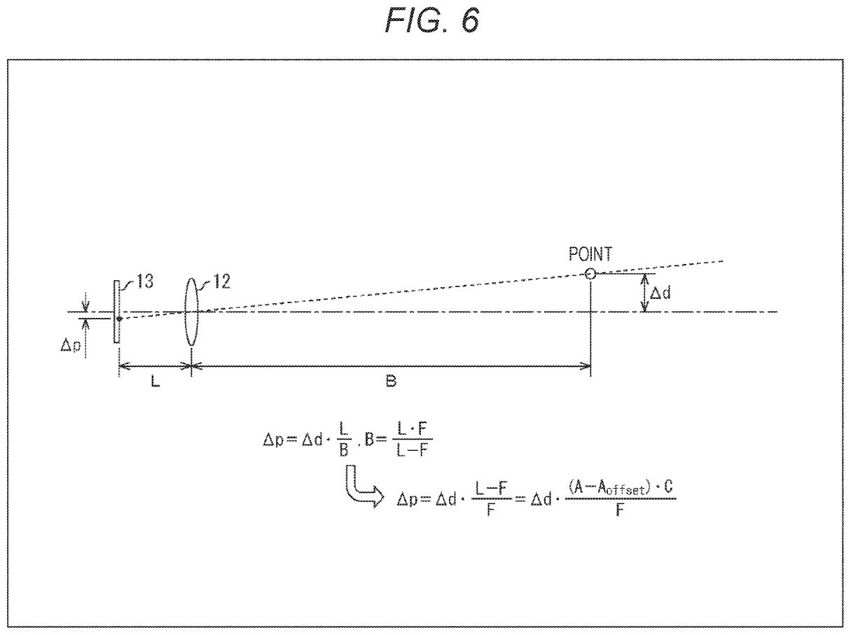

Then, when the lens unit 12 and the image sensor 13 have shift blur in a direction perpendicular to the optical axis direction by a shift movement amount Δd (μm), the movement amount Δp (μm), which moves on the sensor surface of the image sensor 13, of the image corresponding to the point on the object to be imaged in focus can be found by the mathematical expression shown in FIG. 6.

Note that the fact that the lens unit 12 and the image sensor 13 have shift blur of shift movement amount Δd (μm) in a direction perpendicular to the optical axis direction is synonymous with that the object to be imaged has shift blur of Δd (μm) in the opposite direction when viewed from the lens unit 12 and the image sensor 13. Accordingly, FIG. 6 shows that the object to be imaged has shift blur of Δd (μm) in the opposite direction.

Accordingly, the shift blur would be corrected by finding the number of pixels to be corrected in the shift direction from this movement amount Δp (μm), and it is necessary to calculate the shift movement amount Ad in order to find the movement amount Δp (μm).

Thus, in the present embodiment, the angular velocity data (three directions of the pitch direction, the yaw direction, and the roll direction in FIG. 1) and the acceleration data (three directions of the X direction, the Y direction, and the Z direction in FIG. 1) obtained from the motion sensor are sequentially acquired in a time series (several to several tens of times in one frame, or a constant frequency higher than that) in a manner similar to the AF position information in order to find the shift movement amount Ad, and are fed to a signal processing unit in the subsequence stage for use in processing.

Furthermore, in a case where the lens unit 12 and the image sensor 13 have shift blur of a shift movement amount Ad in the optical axis direction and a distance B (μm) between a point on an object to be imaged in focus and the lens unit 12 changes by (B+Δd), the size of the image is multiplied by B/(B+Δd). Accordingly, the movement amount Δp (μm) on the sensor surface of the image sensor 13 differs for each coordinate position when the coordinate (x, y) is set with the center of the optical axis as the center, and the x coordinate and y coordinate of each pixel move to a position multiplied by B/(B+Δd) respectively.

Furthermore, the shift movement amount Ad can be calculated by integrating the acceleration in the shift direction twice. However, the output from the acceleration sensor generally includes the gravitational acceleration. Furthermore, the output value of the sensor itself is not always zero even in a case where the acceleration is zero, and generally, an offset component is included. Moreover, since the gravitational acceleration is applied in three directions according to the tilt of the sensor, the shift movement amount Δd at a certain moment needs to be calculated in consideration of the offset components of the gravitational acceleration, the gravitational acceleration at rest, the inclination of the sensor at that moment found from the angular velocity information acquired in time series, and the like on the basis of the output values of the acceleration or the angular velocity acquired in time series.

That is, assuming that various sensor-specific values and the like are constants, the rotation angle θp(t) in the pitch direction, the rotation angle θy(t) in the yaw direction, and the rotation angle θr(t) in the roll direction at a certain timing t can be expressed by a function of the angular velocity ωp(t) in the pitch direction, the angular velocity ωy(t) in the yaw direction, and the angular velocity ωr(t) in the roll direction at the timing t.

Moreover, the integration results of the acceleration ax(t) in the X direction, the acceleration ay(t) in the Y direction, and the acceleration az(t) in the Z direction at the timing t, the rotation angle θp(t), the rotation angle θy(t), the rotation angle θr(t), and the like are used to find the shift movement amount sx(t) in the X direction, the shift movement amount sy(t) in the Y direction, and the shift movement amount sz(t) in the Z direction of the image sensor 13. In the following, note that (t) representing the timing t will be omitted as appropriate.

That is, the shift movement amount can be calculated by using the angular velocity data and the acceleration data acquired in time series, and the shift movement amount can be expressed as (sx, sy, sz)=S(ωp, ωy, ωr, ax, ay, az), where S is a function for finding the shift movement amount of the image sensor 13.

Moreover, when the image sensor 13 moves in the shift direction with the shift movement amount (sx, sy), how much the image on the sensor surface moves depends on the distance B to the object to be imaged, the focal length F of the lens unit 12, and the distance L from the lens unit 12 to the image sensor 13 as described above with reference to FIGS. 3 and 5. Then, these distances B and L can be found from the AF position information afp at a certain timing, and the number pixels to move can be obtained by dividing these values by the pixel pitch.

For example, considering that the pixel pitch is a value peculiar to the image sensor 13 and the pixel pitch is a constant, the shift movement amount (Δxs, Δys) can be expressed by the following expression (2), where P is a function for finding the shift movement amount on the sensor surface of the image sensor 13 from the shift movement amount (sx, sy, sz) and the AF position information afp.

[Expression 2]

(Δxs, Δys)=P(S(ωp, ωy, ωr, ax, ay, az),afp) (2)

Moreover, the shift movement amount (Δxs, Δys) on the sensor surface of the image sensor 13 can be expressed by the following expression (3), where Qxy is a composite function of the function P and the function S.

[Expression 3]

(Δxs, Δys)=Qxy (ωp, ωy, ωr, ax, ay, az, afp) (3)

In a case where the influence of shift in the optical axis direction is to be considered, note that the influence of movement of shift movement amount sz in the optical axis direction also depends on the pixel position on the sensor surface of the image sensor 13. Thus, the shift movement amount (Δxs, Δys) at the pixel position (x, y) on the sensor surface of the image sensor 13 can be expressed by the following expression (4), where Qxyz is a composite function of a case where the influence of the optical axis direction blur is also added.

[Expression 4]

(Δxs, Δys)=Qxyz (ωp, ωy, ωr, ax, ay, az, afp, x, y) (4)

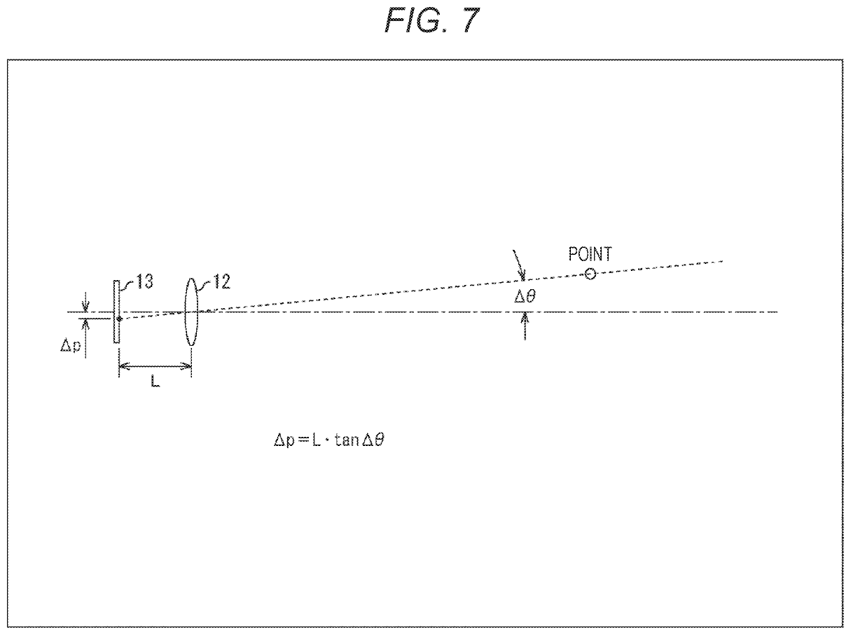

Furthermore, the movement amount Δp due to rotational blur depends on the distance L from the lens unit 12 to the image sensor 13 as expressed by the mathematical expression shown in FIG. 7.

Accordingly, the influence of rotational blur depends on the rotation angle θp, rotation angle θy, and rotation angle θr to be corrected as expressed by the expression (5) described later, the distance L from the lens unit 12 to the image sensor 13, and the pixel position (x, y) on the sensor surface of the image sensor 13. Then, since the rotation angle θp, the rotation angle θy, and the rotation angle θr are found by using the angular velocity cop, the angular velocity ωy, and the angular velocity ωr as variables, and the distance L is found by using the AF position information afp as a variable, the influence of the rotational blur can be expressed as a function of the angular velocity cop, the angular velocity ωy, the angular velocity ωr, the AF position information afp, and the pixel position (x, y) on the sensor surface of the image sensor 13. [0054]

In the present embodiment, in addition to the AF position information, acceleration information, and angular velocity information acquired in these time series, the OIS position information (X direction and Y direction in FIG. 1) is also acquired at the same timing and is sent to the signal processing unit in the subsequent stage for use in processing. Moreover, the acquisition timing information of these information is also sent to the signal processing unit in the subsequent stage for use in processing.

By using this timing information, AF position information (optical axis direction position information), acceleration information, angular velocity information, and OIS position information (perpendicular plane direction position information) at the time of imaging a certain coordinate can be grasped with respect to the coordinate on the sensor surface of the image sensor 13. Therefore, since the distance to an object to be imaged in focus, the shift movement amount, and the rotational blur amount according to each coordinate are calculated using these values, and the amount to be corrected is calculated according to the values, it is possible to perform camera shake correction for all coordinates from the center to the periphery according to the vibration state at the time of photographing each image.

Although it is required to correct all the shift movement amount and the rotational blur amount in a case where the vibration is to be stopped completely, note that the vibration is not necessarily stopped completely and it is of course also possible to limit the correction amount to achieve smooth movement when photographing a moving image or the like.

<Algorithm for obtaining corrected output image>

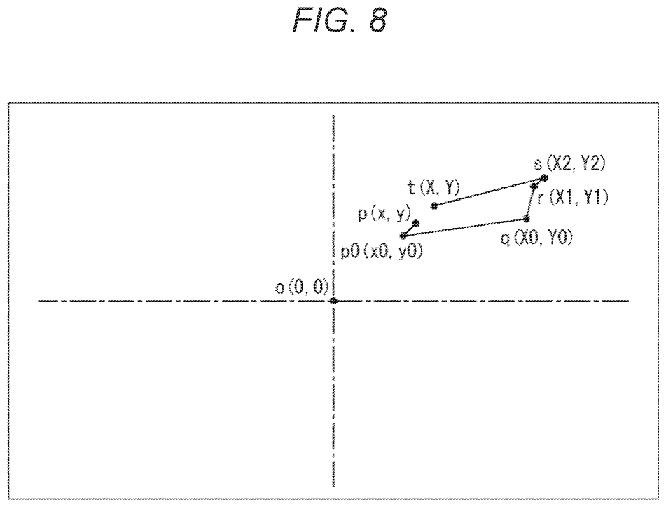

An algorithm for obtaining a corrected output image will be described with reference to FIG. 8.

Note that it is assumed that there are both of a use case where the influence of lens distortion is desired to be removed from the output image subjected to camera shake correction, and a use case where the influence of lens distortion is not desired to be removed (case of desiring imaging at a wide angle and outputting in a distorted state, etc.). Therefore, the following description will give two types of explanation on a case of obtaining a camera shake correction output image in which the influence of the lens distortion is also corrected, and a case of obtaining a camera shake correction output image in which the influence of the lens distortion is left.

First, a case of obtaining a camera shake correction output image in which the influence of lens distortion is also corrected will be described.

For example, in a case where the optical camera shake correction is not operated, the image at point p0 (x0, y0), which is determined by the image pickup device 11 to have a rotational blur of −θₚ in the pitch direction, a rotational blur of -e in the yaw direction, and a rotational blur of−θᵣ in the roll direction, moves to point q (X0, Y0 ) in the absence of lens distortion. At this time, the coordinate values of the point q (X0, Y0 ) are found by the following expression (5) as disclosed in Patent Documents 1 and 2 described above.

$$\begin{matrix} [ Expression 5 ] & \\ \{ \begin{matrix}X 0 = L \cdot ( tan ( α + {θ}_{y} ) ) + x 0 \cdot \frac{cos β}{cos ( β + {θ}_{p} )} + x 0 \cdot cos {θ}_{r} - y 0 \cdot sin {θ}_{r} - 2 \cdot x 0 \\ Y 0 = L \cdot ( tan ( β + {θ}_{p} ) ) + y 0 \cdot \frac{cos α}{cos ( α + {θ}_{p} )} + x 0 \cdot sin {θ}_{r} + y 0 \cdot cos {θ}_{r} - 2 \cdot y 0\end{matrix} \\ tan α = \frac{x 0}{L} \\ tan β = \frac{y 0}{L} & ( 5 )\end{matrix}$$

Note that L used in this expression (5) represents the distance L from the lens unit 12 to the image sensor 13 (e.g., see FIGS. 5 to 7) in pixel units, and the value at each timing can be calculated from the AF position information as described above. Although a fixed value may be used for this value in order to simplify the calculation, a value at each timing can be obtained by using the AF position information at each timing in the present embodiment, and therefore it is possible to calculate the movement amount more accurately.

Moreover, assuming that the point q (X0, Y0 ) moves on the sensor surface of the image sensor 13 to the point r (X1, Y1) by the movement amount Asx and the movement amount Asy when the image pickup device 11 moves by −sx in the X direction, −sy in the Y direction, and sz in the Z direction, the point r (X1, Y1) is expressed by the following expression (6).

[Expression 6]

r(X1, Y1)=q(X0, Y0)+(Δsx, Δsy) (6)

Since it is actually affected by the lens distortion, note that it is assumed that the point r (X1, Y1) moves to the point s (X2, Y2) due to the influence of the lens distortion, and the point s (X2, Y2) is expressed by the following expression (7), where D ( ) is a function representing the influence of the lens distortion.

[Expression 7]

s(X2, Y2)=D (r(X1, Y1)) (7)

Then, in a case where OIS is not used and only EIS is used, it is possible to obtain an image subjected to six-axes camera shake correction by outputting the pixel value of this point s (X2, Y2) as the pixel value of point p0 (x0, y0).

Since the influence of the lens distortion accurately also depends on the distance L from the lens unit 12 to the image sensor 13, note that the influence of distortion can be calculated more accurately by considering the influence of the value of the distance L at each timing calculated from the AF position information with the function D ( ) representing the influence of the lens distortion.

By performing these calculations for all the pixels on the output screen and calculating the output pixel values to generate the output image, it is possible to obtain an image in which positional deviation due to vibration, peripheral deformation, focal plane distortion, and lens distortion are corrected, from the center to the periphery of the screen. However, the influence of exposure blur (that is blur of a point image during exposure and is also referred to as in-exposure blur or blur within exposure time) remains.

Although a specific value or the like will be used instead in a case where point s (X2, Y2) indicates a value outside the input image, note that it is necessary to consider, when configuring the system, to make input image have a larger range than the output image so that such a value does not appear at all, to limit the correction range so that it does not refer to the outside of the input image, or the like.

Furthermore, in a case where an output without lens distortion correction is desired, it is only required to use the pixel value of point s (X2, Y2) calculated based on position p0 (x0, yO) obtained by applying lens distortion correction to p (x, y) as the output value of point p (x, y) on the output image. That is, the point p0 (x0, y0) is expressed as shown in the following expression (8) using the lens distortion correction function D⁻¹ ( ) which is the inverse function of the lens distortion influence function D ( ).

[Expression 8]

p0 (x0, y0)=D⁻¹ (p (x, y)) (8)

In either case, note that the X coordinate X2 and the Y coordinate Y2 of the point s (X2, Y2) are rarely integers. Accordingly, the output pixel value is found by calculating the output pixel value by interpolation processing from the peripheral image angle value, substitution with the value of the nearest pixel, or the like.

Moreover, in a case where correction by OIS is added, the point t (X, Y) is expressed by the following expression (9) using the OIS correction amounts Δx ois and Δy ois when the point s (X2, Y2) moves to the point t (X, Y).

[Expression 9]

t(X, Y)=s(X2, Y2)−(Δx, oix, Δy ois) (9)

Here, the OIS correction amounts Δx ois and Δy ois are pixel units of the lens movement amount calculated on the basis of the OIS lens position information at each timing.

Accordingly, in a case where an output with the influence of lens distortion corrected is to be obtained, it is possible to obtain an image obtained by applying six-axes camera shake correction to an OIS image by outputting the pixel value of point t (X, Y) as the pixel value of point p0 (x0, y0).

At this time, if the pixel value of point t (X, Y) is outputted as the pixel value of point p0 (x0, y0), it is possible to obtain a result in which the influence of exposure blur is corrected in addition to the six-axes camera shake correction result obtained only by EIS regardless of whether the correction by OIS is two-axes correction in the pitch direction and the yaw direction, or four-axes correction including shifts in the x direction and the y direction in addition to the pitch direction and the yaw direction. However, in a case where the OIS correction is only for two axes of the pitch direction and the yaw direction, the exposure blur will remain with respect to the shift blur.

Furthermore, similar to the case of using only EIS, it is only required to use the pixel value of point t (X, Y) calculated based on position p0 (x0, y0) obtained by applying lens distortion correction to point p (x, y) as the output value of the point p (x, y) on the output image in a case where the result without lens distortion correction is desired. That is, the point p0 (x0, y0) is calculated by the expression (8) described above, using the lens distortion correction function D⁻¹ ( ) which is the inverse function of the lens distortion influence function D ( ).

Therefore, if the pixel value of the point t (X, Y) is outputted as the output value of the point p (x, y) on the output image, a camera shake correction output result without lens distortion correction can be obtained.

In each case, it is possible to find the coordinate value in a corresponding input image using a function including variables of the coordinate of the output image, the angular velocity at the time of imaging each pixel, the acceleration, the OIS position information, and the AF position information, in addition to the individual specific values, and to obtain an output image subjected to camera shake correction by using the pixel value of the coordinate.

Furthermore, in order to find the pixel value of each point of the output image, the pixel value can be calculated by calculating the corresponding coordinate position on the input image using the above-described function for each point. In addition, the pixel value may be calculated by, for example, dividing the output image, calculating the corresponding coordinate position only of the grid points on the input image using the above-described function, and finding the coordinate position other than the grid points by interpolation calculation.

Although an example of correcting the rotational blur in the pitch direction, the yaw direction, and the roll direction in FIG. 1 and the shift blur in the X direction, the Y direction, and the Z direction has been described in the present embodiment, note that it is of course also effective in cases other than six axes, such as five-axes correction in which shift blur in the Z direction is not corrected or a case where correction of rotational blur in the roll direction is not performed.

However, when employing a combination that the OIS corrects the four axes of rotational blur in the pitch direction and the yaw direction and shift blur in the X direction and Y direction while the EIS corrects rotational blur in only three axes of the pitch direction, the yaw direction, and the roll direction and does not correct shift blur in the X direction and the Y direction, it is to be noted that the EIS cancels the vibration in the shift direction that the OIS has stopped.

<First Configuration Example of Image Pickup Device to Which the Present Technology is Applied>

Hereinafter, specific embodiments to which the present technology is applied will be described in detail with reference to the drawings.

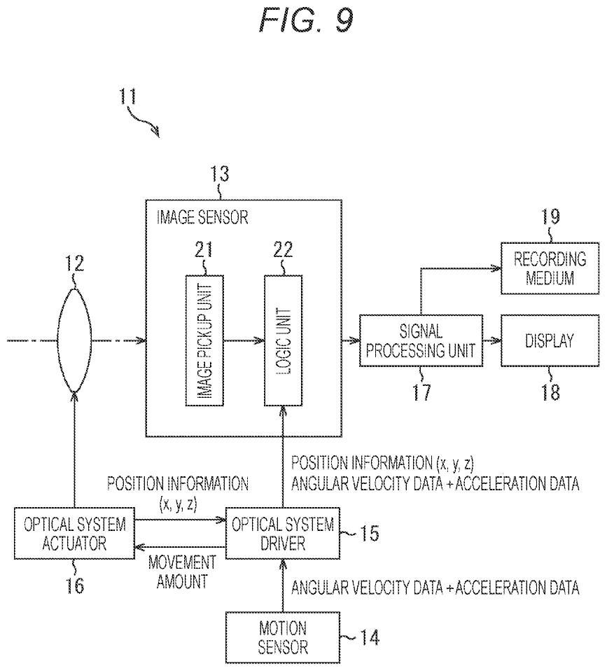

FIG. 9 is a block diagram showing a configuration example of the first embodiment of an image pickup device to which the present technology is applied.

As shown in FIG. 9, the image pickup device 11 includes the lens unit 12, the image sensor 13, a motion sensor 14, an optical system driver 15, an optical system actuator 16, a signal processing unit 17, a display 18, and a recording medium 19.

The lens unit 12 includes one or a plurality of lenses, collects light from an object, and forms an image of the object on the sensor surface of an image pickup unit 21 included in the image sensor 13.

The image sensor 13 is configured by stacking a semiconductor chip on which the image pickup unit 21 is formed, and a semiconductor chip on which a logic unit 22 is formed, and is equipped with an interface for capturing an output from the optical system driver 15.

The image pickup unit 21 captures an image of an object formed on a sensor surface where light from the object is collected by the lens unit 12 and a plurality of pixels is arranged in a matrix, and outputs an image acquired by the image pickup.

The logic unit 22 supplies the signal processing unit 17 with image data obtained by adding the position information, the angular velocity data, and the acceleration data of the lens unit 12 outputted from the optical system driver 15 to an image captured by the image pickup unit 21 together with timing information indicating timing at which the data are synchronized with a coordinate on the image.

Specifically, the logic unit 22 receives the angular velocity data and acceleration data detected by the motion sensor 14, and the position information (OIS-driven lens position, AF-driven lens position) of the lens unit 12 driven by the optical system actuator 16 at a predetermined sampling frequency (e.g., 1 kHz) from the optical system driver 15. Then, the logic unit 22 adds the position information, the angular velocity data, and the acceleration data of the lens unit 12, and the value of the H line counter of the image data at the timing of receiving the data to the image data and outputs data.

Of course, the position information, the angular velocity data, and the acceleration data of the lens unit 12, and the value of the H line counter may be outputted individually together with the image, without being added to the image. Then, the position information, the angular velocity data, and the acceleration data of the lens unit 12 are associated with each other by the value of the H line counter in units of one line in the horizontal direction of the image data, so that the signal processing unit 17 can synchronize the angular velocity data, the acceleration data, and the position information with the perpendicular position of the image. That is, the value of the H line counter is used as timing information for synchronizing them.

Here, the H line counter of the image data is, for example, a counter that is reset for every frame at predetermined timing and increases by one every time one line in the horizontal direction is read, and is used for adjusting the timing of the perpendicular position of the image. Note that the H line counter is also counted in a blank section where no image is read. Furthermore, in addition to using the H line counter of the image data, for example, time information such as a time stamp may be used as the timing information. Note that the method of synchronizing the angular velocity data, the acceleration data, and the position information with the perpendicular position of the image is described in detail in Patent Document 2 described above.

Note that it is necessary to adjust the correspondence between the actual image position on the image sensor 13 and the position information, angular velocity data, and acceleration data of the lens unit 12 in consideration of a delay between timing at which each data is actually acquired and the time at which a time stamp such as H line counter is added, the length of the exposure time with the image sensor 13, and the like.

The motion sensor 14 physically detects the movement of the image pickup unit 21 (not by image processing) and outputs information representing the movement.

For example, the motion sensor 14 includes a gyro sensor capable of detecting angular velocities in three axial directions of the pitch direction, the yaw direction, and the roll direction as shown in FIG. 1, and an acceleration sensor that can detect accelerations in three axial directions of the X direction, the Y direction, and the Z direction, and outputs angular velocity data represented by those angular velocities and acceleration data represented by the acceleration as information representing the movement of the image pickup device 11.

In addition to using a device dedicated to OIS control as the motion sensor 14, for example, note that a motion sensor incorporated in a device for another purpose can be used in common for the OIS control, or a motion sensor for acquiring information to be sent to an image processing unit can be used separately from the OIS control. Furthermore, the motion sensor 14 is not limited to the six-axes sensor capable of outputting acceleration data in addition to the angular velocity data in the three axis directions, and the gyro sensor and the acceleration sensor can be individually connected, or a multi-axes sensor or a composite sensor with six or more axes further having a geomagnetic sensor or the like added thereto can also be used.

The optical system driver 15 calculates the movement amount of moving the lens unit 12 to optically cancel occurrence of blur on the image captured by the image pickup unit 21 on the basis of the angular velocity data and acceleration data outputted from the motion sensor 14. Then, the optical system driver 15 supplies the calculated movement amount to the optical system actuator 16 and controls so that the lens unit 12 is arranged at a predetermined position according to the movement amount.

Furthermore, the optical system driver 15 performs AF control according to an instruction from an AF control unit (not shown). Moreover, the optical system driver 15 acquires the position information of the lens unit 12 driven by the optical system actuator 16, and outputs the position information, angular velocity data, and acceleration data of the lens unit 12 to the image sensor 13.

The optical system actuator 16 drives the lens unit 12 according to the movement amount instructed by the optical system driver 15, thereby optically correcting the camera shake generated in an image captured by the image sensor 13. Furthermore, the optical system actuator 16 also adjusts the focus position. Then, the optical system actuator 16 detects the position of the lens unit 12 driven, and supplies the position information of the lens unit 12 to the optical system driver 15.

The signal processing unit 17 performs signal processing of correcting an influence (e.g., positional deviation, peripheral deformation, distortion caused by rolling shutter, deformation due to influence of lens distortion, etc.) of movement of the image pickup unit 21 on the image according to a function that performs correction described above using the position information, angular velocity data, and acceleration data of the lens unit 12 synchronized for each coordinate on the image on the basis of the image data supplied from the image sensor 13, and the position information, angular velocity data, acceleration data, and timing information of the lens unit 12 added to the image data.

The display 18 includes, for example, a display unit such as a liquid crystal panel or an organic electro luminescence (EL) panel, and displays an image outputted from the signal processing unit 17.

The recording medium 19 is a removable type memory that is built in the image pickup device 11 or is detachable from the image pickup device 11, and records an image outputted from the signal processing unit 17.

The image pickup device 11 is configured in this way, and the signal processing unit 17 can perform a correction process by electronic camera shake correction on an image captured by the image sensor 13 so as to optically suppress the occurrence of blur. Therefore, the image pickup device 11 can suppress occurrence of blur within the exposure time, and correct image blur (positional deviation due to camera shake, peripheral deformation, distortion caused by rolling shutter, deformation due to influence of lens distortion, etc.).

Although a barrel shift type optical camera shake correction in which the lens unit 12 is driven by the optical system actuator 16 is described in the present embodiment, note that a sensor shift type optical camera shake correction, in which the image sensor 13 is driven by the optical system actuator 16, may be employed in the image pickup device 11. In this case, the optical system actuator 16 supplies the position information of the image sensor 13 to the optical system driver 15 instead of the position information of the lens unit 12.

Furthermore, a sensor shift type that moves the image sensor 13 may be used for OIS, and a barrel shift type that moves the lens unit may be used for AF.

Furthermore, the image pickup device 11 in FIG. 9 is configured so that the angular velocity data and acceleration data outputted from the motion sensor 14 are supplied to the image sensor 13 via the optical system driver 15. On the other hand, in the image pickup device 11, the motion sensor 14 may include two output ports used for outputting the angular velocity data and the acceleration data, for example, so that the angular velocity data and the acceleration data are supplied respectively from the motion sensor 14 to the image sensor 13 and the optical system driver 15. In this case, the angular velocity data and the acceleration data are not supplied from the optical system driver 15 to the image sensor 13.

Alternatively, the image pickup device 11 may include two motion sensors 14, for example, so that angular velocity data and acceleration data are supplied respectively from the two motion sensors 14 to the image sensor 13 and the optical system driver 15. Furthermore, in this case, the angular velocity data and the acceleration data are also not supplied from the optical system driver 15 to the image sensor 13.

Moreover, although the image sensor 13 and the signal processing unit 17 are shown as different blocks in the image pickup device 11 shown in FIG. 9, a configuration may be employed in which the signal processing unit 17 performs processing inside the image sensor 13, for example. That is, the image sensor 13 may have a laminated structure in which semiconductor chips on which the signal processing unit 17 is formed are laminated.

<Camera Shake Correction Process of Image Pickup Device>

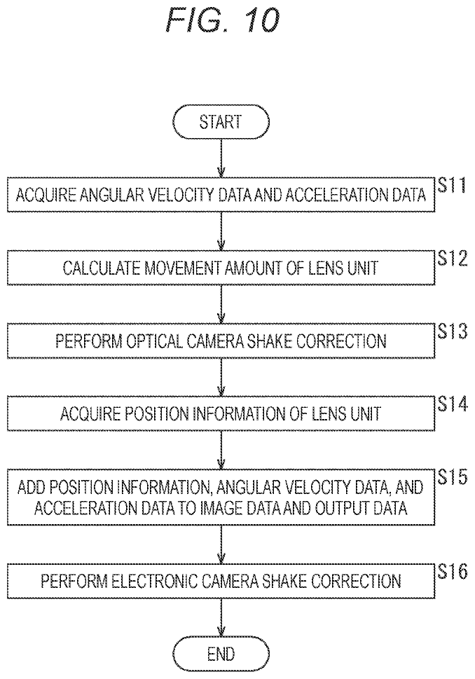

An example of the camera shake correction process to be executed in the image pickup method by the image pickup device 11 will be described with reference to the flowchart of FIG. 10.

For example, in the image pickup device 11, the camera shake correction process is started when the image pickup unit 21 starts capturing an image of one frame, and in step S11, the optical system driver 15 acquires the angular velocity data and acceleration data outputted from the motion sensor 14.

In step S12, the optical system driver 15 calculates the movement amount of moving the lens unit 12 on the basis of the angular velocity data and acceleration data acquired in step S11, and supplies the movement amount to the optical system actuator 16.

In step S13, the optical system actuator 16 performs optical camera shake correction by driving the lens unit 12 according to the movement amount supplied from the optical system driver 15 in step S12.

In step S14, the optical system actuator 16 detects the position of the lens unit 12 driven in step S13, and supplies the position information of the lens unit 12 to the optical system driver 15. Then, the optical system driver 15 supplies the position information of the lens unit 12 and the angular velocity data and acceleration data acquired in step S11 to the logic unit 22 of the image sensor 13.

In step S15, the logic unit 22 adds the position information, angular velocity data, and acceleration data of the lens unit 12 supplied from the optical system driver 15 in step S14 to the image data outputted from the image pickup unit 21 together with the value of the H line counter of the image data corresponding to the timing of receiving the data and supplies the data to the signal processing unit 17.

In step S16, the signal processing unit 17 uses the position information, angular velocity data, and acceleration data of the lens unit 12 to perform an electronic camera shake correction process on the image data supplied in step S15 according to a function that converts the position for each coordinate of the image data synchronized with the same. Thereafter, the process is terminated, and similar processes are repeatedly performed each time the image pickup unit 21 starts imaging the next one frame. Note that the correction process is not terminated but continuously performed in the case of photographing of a moving image or the like to which camera shake correction is to be performed continuously, preview screen, continuous photographing of a still image, or the like. Furthermore, the processes from step S11 to step S14 are continuously performed at a preset sampling frequency.

As described above, the image pickup device 11 can suppress the occurrence of blur within the exposure time by optical camera shake correction under the control of the optical system driver 15, suppress the influence of camera shake on the image by an electronic camera shake correction process by the signal processing unit 17, and surely correct the blur.

<Resetting the Correction Position of Optical Camera Shake Correction>

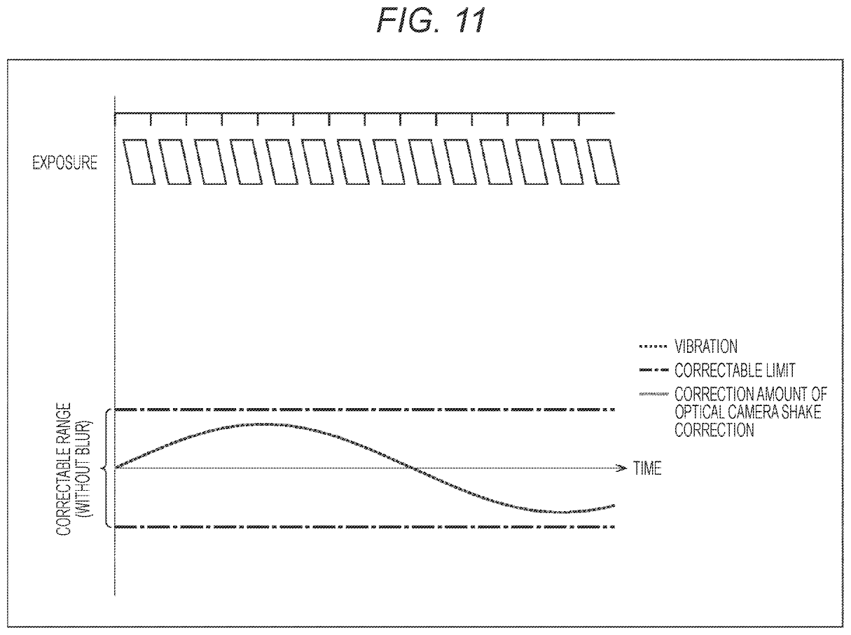

With reference to FIGS. 11 to 13, the above-described camera shake correction process performed while resetting the correction position of the optical camera shake correction during the non-exposure period between frames will be described. In this way, by resetting the correction position of the optical camera shake correction, it is possible to correct positional deviation, peripheral deformation, focal plane distortion, a difference in positional deviation amount due to lens distortion, and the like including the in-exposure blur even for the blur of the angle and the blur of the shift amount that cannot be corrected by ordinary optical camera shake correction.

For example, in ordinary optical camera shake correction, it is possible to achieve correction so that exposure blur does not occur if the vibration is week as shown in FIG. 11.

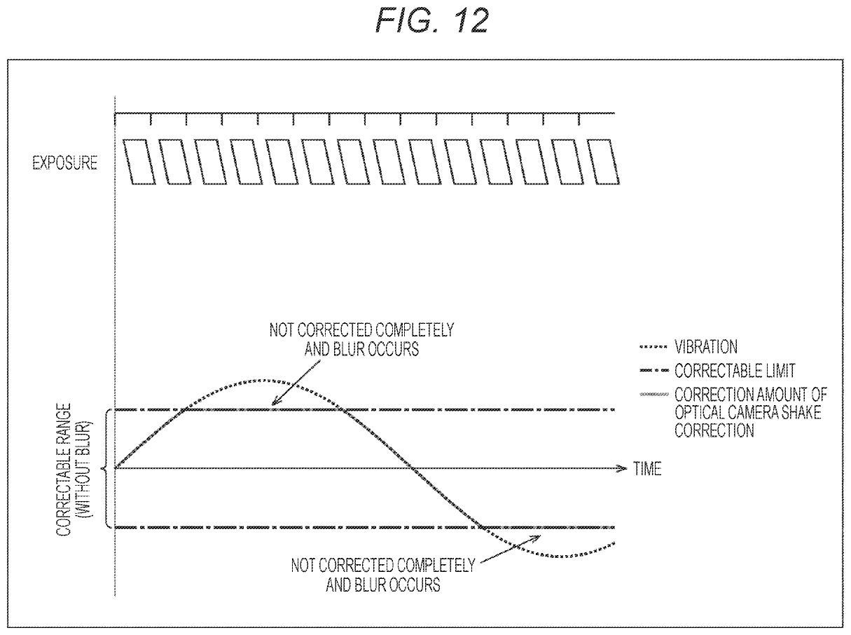

On the other hand, if vibration becomes strong, it cannot be corrected within the correctable range of the optical camera shake correction, and therefore exposure blur occurs as shown in FIG. 12.

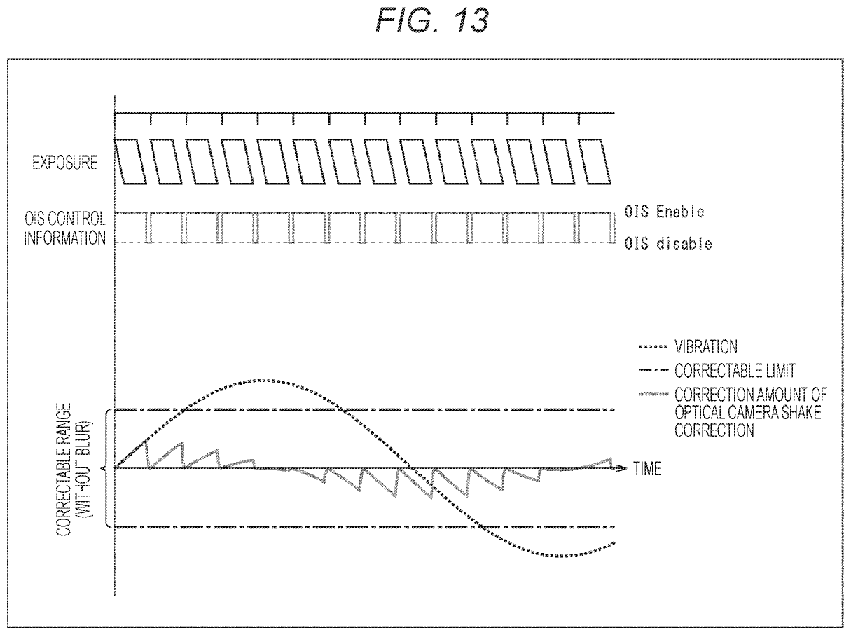

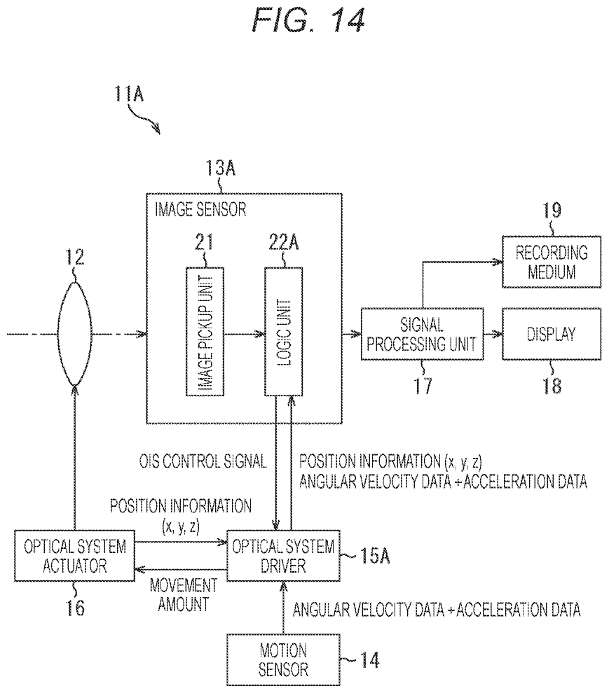

Thus, an image pickup device 11A shown in FIG. 14, which will be described later, is configured to reset (center returning process) the relative positional relationship between the lens position and the image sensor position of the optical camera shake correction during the non-exposure period, and perform control to achieve optical camera shake correction at the exposure time, so as to photograph an image without exposure blur even in strong vibration condition as shown in FIG. 13.

In this case, although exposure blur does not occur in the frame but the image position on the screen moves between frames on the output result of the optical camera shake correction, it is possible to also stop movement of the image position between the frames by applying the EIS process described above for this OIS output image. That is, it is possible to correct the influences of positional deviation, peripheral deformation, focal plane deformation, and lens distortion without exposure blur even with strong vibration that would cause exposure blur in ordinary OIS.

Especially in the case of four-axes correction with OIS, the OIS correction range is used for both rotational blur correction and shift blur correction, and therefore it is easy to exceed the OIS correction range, and the method of resetting the OIS during a non-exposure period is extremely effective.

<Second Configuration Example of Image Pickup Device to which the Present Technology is Applied>

FIG. 14 is a block diagram showing a configuration example of the second embodiment of an image pickup device to which the present technology is applied. In the image pickup device 11A shown in FIG. 14, note that configurations common to the image pickup device 11 in FIG. 9 are denoted by the same reference numerals, and detailed description thereof will be omitted.

Similar to the image pickup device 11 in FIG. 9, the image pickup device 11A includes the lens unit 12, the motion sensor 14, the optical system actuator 16, the signal processing unit 17, the display 18, the recording medium 19, and the image pickup unit 21 as shown in FIG. 14.

Then, the image pickup device 11A has a configuration in which a logic unit 22A of an image sensor 13A and an optical system driver 15A are different from those of the image pickup device 11 in FIG. 9.

In addition to the functions of the logic unit 22 shown in FIG. 9, the logic unit 22A has a function of generating OIS control information instructing execution or stop of optical camera shake correction according to the exposure timing, at which the image pickup unit 21 performs exposure, and supplying the OIS control information to the optical system driver 15A. Note that the process of generating OIS control information according to the exposure timing of the image pickup unit 21 may be performed outside the image sensor 13A. However, it is preferable that this process is performed in the logic unit 22A built in the image sensor 13A.

For example, the logic unit 22A generates OIS control information on the basis of the exposure end (reading out end) timing of the image pickup unit 21 and the exposure start timing of the next frame. Furthermore, the logic unit 22A can specify the exposure start timing of the next frame on the basis of information such as the time between frames and the exposure time of the next frame (that changes depending on the imaging conditions due to automatic exposure function, etc.). Since these timings are determined and operated inside the image sensor 13A, the logic unit 22A can generate the OIS control information more easily as compared with the configuration in which the OIS control information is generated outside the image sensor 13A.

In addition to the functions of the optical system driver 15 shown in FIG. 9, the optical system driver 15A has a function of performing operation to return the lens unit 12 to the center position in a case where the OIS control information instructs stop of optical camera shake correction, on the basis of the OIS control information supplied from the logic unit 22A.

In the image pickup device 11A configured in this way, the logic unit 22A supplies the OIS control information to the optical system driver 15A, so that a center returning process of optical camera shake correction can be performed between the frames. Therefore, the image pickup device 11A can perform optical camera shake correction while resetting the lens position between the frames, so that correction using the entire range that can be corrected by the optical camera shake correction is always performed in each frame.

That is, in the image pickup device 11 shown in FIG. 9, the blur within the exposure time cannot be suppressed during vibration in the exceeding range in a case where vibration having an amplitude exceeding the correctable range of the optical camera shake correction is generated (see FIG. 12). On the other hand, by performing the center returning process (see FIG. 13) of the optical camera shake correction, the image pickup device 11A can suppress the occurrence of blur within the exposure time as long as the vibration in one frame is within a certain angle at which optical camera shake correction can be performed, even if a large amplitude vibration occurs.

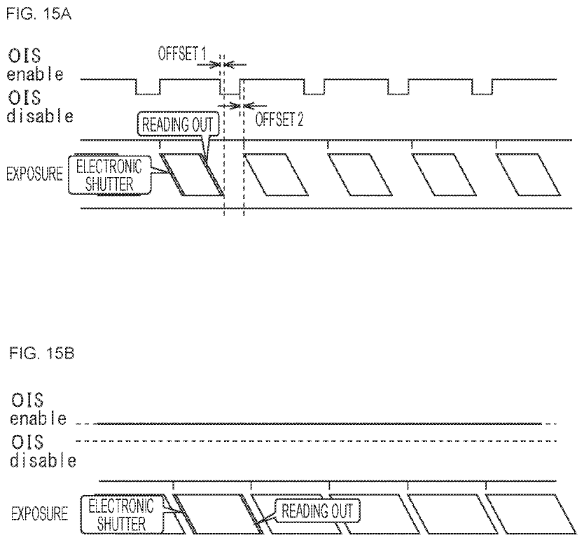

The OIS control information generated by the logic unit 22A will be described with reference to FIG. 15.

Note that the horizontal axis of the graph shown in FIG. 15 is time, and shows the change with time. Furthermore, the parallelogram in the figure schematically represents the time for reading image data while exposing the image from the top to the bottom (it may be from the bottom to the top depending on the imaging setting) when photographing an image with a CMOS image sensor. In the illustrated example, the electronic shutters are opened in order from the top of the image, exposure is performed for a certain period of time, and then reading out is performed in order from the top.

As shown in A of FIG. 15, the logic unit 22A outputs OIS control information (OIS enable) instructing execution of optical camera shake correction during a period when exposure is being performed in a case where there is a time (non-exposure period) when the exposure does not overlap between frames from the end of reading out of the bottom of the image to the opening of the electronic shutter at the top of the image in the next frame. Furthermore, the logic unit 22A outputs OIS control information (OIS disable) instructing stop of the optical camera shake correction during a period when exposure is not being performed. For example, the logic unit 22A outputs OIS control information (OIS disable) instructing stop of the optical camera shake correction in a case where the time from the end of exposure to the start of the next exposure is equal to or longer than a predetermined time that has been set.

Note that the logic unit 22A can shift the timing of switching between execution and stop of optical camera shake correction by each set offset time (offset 1 and offset 2 shown in FIG. 15) from the reading end timing or the exposure start timing in consideration of the actual control delay.

On the other hand, in a case where the period when the exposure does not overlap between the frames does not occur as shown in B of FIG. 15, or in a case where the period when the exposure does not overlap between the frames is shorter than a predetermined time that has been set, the logic unit 22A always outputs OIS control information (OIS enable) instructing execution of optical camera shake correction. That is, in a case where the exposure always overlaps between the frames, the optical camera shake correction is continuously performed, and the center returning process of the optical camera shake correction is not performed.

In a case where the lens unit 12 can be reset to the center position between the frames as described above, the correction range of the optical camera shake correction can always be enlarged. Thus, even in a case where the image cannot be completely corrected by ordinary optical camera shake correction and camera shake remains as shown in FIG. 13, the image can be corrected, and an image without camera shake can be obtained.

Furthermore, in a case where the non-exposure period is shorter than the time sufficient to reset the lens unit 12 to the center position, it is also possible to return the lens halfway toward the center and control to perform optical camera shake correction from that position together with the start of exposure. Even in this case, the correction range of the optical camera shake correction for each frame can be enlarged to some extent. Note that it is desirable to set a threshold time required to perform control such as the reset operation to return the lens to the center position or the optical camera shake correction operation according to the performance of the control system, and output OIS control information (OIS disable) in a case where there is a non-exposure period equal to or longer than the threshold time.

Although it becomes impossible to sufficiently suppress blur within the exposure time in a case where vibration with an amplitude exceeding the correctable range of the optical camera shake correction occurs during exposure in the frame, note that it is possible to effectively perform electronic camera shake correction even in that case, and therefore the blur of the image can be corrected and the image is not broken.

Furthermore, the image pickup device 11A performs signal processing for each coordinate on the image to perform correction on the basis of the angular velocity data and acceleration data outputted from the motion sensor 14, and the position information of the lens unit 12. Thus, in a case where the lens unit 12 returns to the center, in a case where ordinary optical camera shake correction is applied, and in a case where the lens unit 12 is always fixed at the center position (the case of correction only by EIS), for example, the signal processing unit 17 can perform processing using the same algorithm.

As described above, even if the optical camera shake correction can be performed for two axes for correcting rotational blur in the pitch direction and the yaw direction, the image pickup device 11 can use the electronic camera shake correction to correct rotational blur in the roll direction in addition to the pitch direction and the yaw direction, and shift blur in the three axes of the X direction, the Y direction, and the Z direction. Moreover, it is possible to obtain an image with no in-exposure blur, no positional deviation, no peripheral deformation in the screen, and no influence of focal plane distortion or lens distortion for two axes that correct rotational blur in the pitch direction and the yaw direction.

In particular, the image pickup device 11 can achieve positional correction for movement that cannot be completely corrected by optical camera shake correction, since the correction range of the electronic camera shake correction can be widened accordingly as the angle of view of the output image is made smaller than the angle of view of the input image.

Moreover, in a case where an image pickup device 11 that can correct shift blur in two axes of the X direction and the Y direction in addition to correcting rotational blur in two axes of the pitch direction and the yaw direction as optical camera shake correction is used, it is possible to obtain an image in which in-exposure blur in two axes in the shift direction is suppressed in addition to the above.

Moreover, the image pickup device 11A can reset the movement of the optical camera shake correction (return to the center position) during the non-exposure period between the frames, so that it becomes possible to suppress in-exposure blur as long as vibration within the exposure period of one frame does not exceed the range in which optical camera shake can be corrected. Accordingly, as compared with the case where such a reset (return to the center position) is not performed, the number of cases that cannot be corrected by the optical camera shake correction is overwhelmingly reduced. That is, it is possible to obtain an image that is almost always free from exposure blur and is not affected by positional deviation, peripheral deformation in the screen, focal plane distortion, or lens distortion for four axes.

<Usage Examples of Image Sensor>

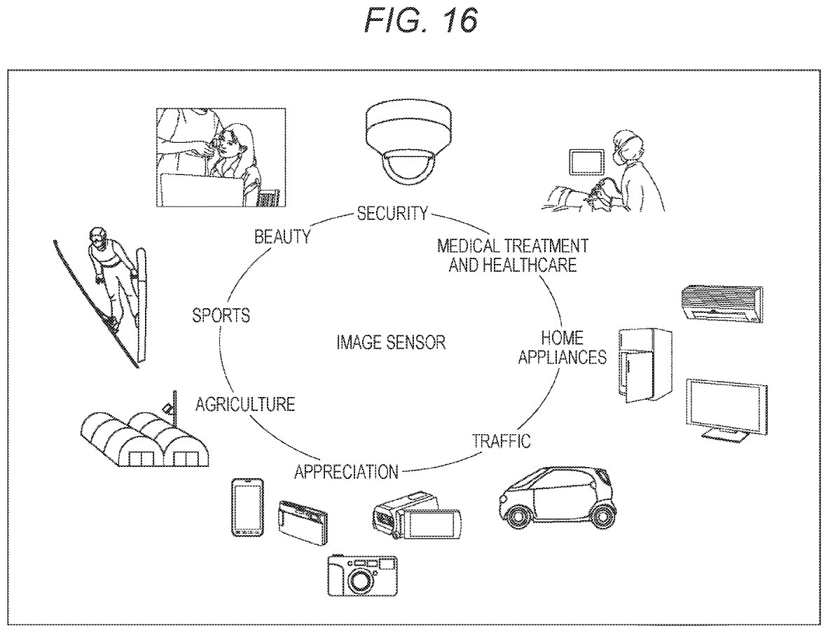

FIG. 16 is a diagram showing usage examples of using the image sensor (image pickup element) described above.

The image sensor described above can be used in various cases for sensing light such as visible light, infrared light, ultraviolet light, and X ray, as described below, for example.
Devices that capture images used for appreciation, such as digital cameras, and mobile apparatuses with camera functions
Devices used for traffic, such as in-vehicle sensors that image the front, rear, surroundings, inside, and the like of the vehicle for safe driving such as automatic stop or recognition of the driver's condition or the like, surveillance cameras that monitor traveling vehicles or roads, and distance measurement sensors that measure distance between vehicles and the like
Devices used for home appliances, such as TVs, refrigerators, and air conditioners to image user gestures and operate apparatuses according to those gestures
Devices used for medical treatment and healthcare, such as endoscopes, and devices that perform angiography by receiving infrared light
Devices used for security, such as surveillance cameras for crime prevention and cameras for personal authentication
Devices used for beauty, such as skin measuring devices that image the skin, and microscopes that image the scalp
Devices used for sports, such as action cameras and wearable cameras for sports applications
Devices used for agriculture, such as cameras for monitoring the condition of fields or crops

<Examples of Configuration Combination>

Note that the present technology may also have the following configurations.

(1)

An image pickup device including:

an image pickup unit configured to capture an image of an object via an optical system that collects light from the object;

a drive control unit configured to find a movement amount in a process of relatively moving at least one of the optical system and the image pickup unit and performing optical correction of blur appearing on an image captured by the image pickup unit on the basis of physically detected movement of the image pickup unit and control drive of at least one of the optical system and the image pickup unit; and

a signal processing unit configured to perform signal processing of correcting an influence of movement of the image pickup unit on the image according to a function that converts a position using perpendicular plane direction position information, movement information, and optical axis direction position information synchronized for each coordinate on the image on the basis of the perpendicular plane direction position information in which a position of the optical system or the image pickup unit driven in a plane direction perpendicular to an optical axis direction under control by the drive control unit is detected, the movement information representing physically detected movement of the image pickup unit, and the optical axis direction position information indicating a relative position in an optical axis direction between the optical system and the image pickup unit.

(2)

The image pickup device according to (1),

in which angular velocity information indicating angular velocity generated in the image pickup unit, and acceleration information indicating acceleration generated in the image pickup unit are used as the movement information.

(3)

The image pickup device according to (1) or (2),

in which the optical axis direction position information is based on a distance between the optical system and the image pickup unit in a process of autofocusing the object under control by the drive control unit.

(4)

The image pickup device according to any one of (1) to (3),

in which the signal processing unit performs the signal processing on five axes or six axes of movement of the image pickup unit for each coordinate on the image.

(5)

The image pickup device according to any one of (1) to (4), further including

a logic unit that supplies the perpendicular plane direction position information, the movement information, and the optical axis direction position information, and timing information indicating timing to synchronize the perpendicular plane direction position information, the movement information, and the optical axis direction position information with a coordinate on the image to the signal processing unit together with an image captured by the image pickup unit.

(6)

The image pickup device according to (5),

in which the logic unit adds the perpendicular plane direction position information, the movement information, and the optical axis direction position information to the image together with the timing information and outputs information.

(7)

The image pickup device according to (5) or (6), in which the logic unit associates information indicating a perpendicular position of the image with the perpendicular plane direction position information, the movement information, and the optical axis direction position information in units of one line of the perpendicular position as the timing information and outputs information.

(8)

The image pickup device according to any one of (5) to (7), further including

an image sensor configured by stacking the image pickup unit and the logic unit,

in which the perpendicular plane direction position information, the movement information, the optical axis direction position information, and the timing information are supplied from the image sensor to the signal processing unit together with the image.

(9)

The image pickup device according to any one of (1) to (8), further including

a drive unit configured to drive at least one of the optical system and the image pickup unit in a plane direction perpendicular to an optical axis direction according to the movement amount found by the drive control unit, detect a position of the optical system or the image pickup unit according to the drive, supply the perpendicular plane direction position information to the drive control unit, perform drive of displacing a distance between the optical system and the image pickup unit in an optical axis direction in a process of autofocusing the object under control by the drive control unit, detect a position of the optical system or the image pickup unit according to the drive, and supply the optical axis direction position information to the drive control unit.

(10)

The image pickup device according to any one of (5) to (9), further including

a detection unit that physically detects movement of the image pickup unit and supplies the movement information to the drive control unit,

in which the perpendicular plane direction position information, the movement information, and the optical axis direction position information are supplied from the drive control unit to the logic unit.

(11)

The image pickup device according to (5),

in which the logic unit generates control information instructing execution or stop of the optical correction according to exposure timing at which the image pickup unit performs exposure, and supplies the control information to the drive control unit, and

the drive control unit controls drive of at least one of the optical system and the image pickup unit on the basis of the control information during a period when the optical correction is being executed so as to perform optical correction of blur appearing on an image captured by the image pickup unit and pull the optical system or the image pickup unit back to a center position while the optical correction is being stopped.

(12)

The image pickup device according to (11), in which the drive control unit controls drive so as to move the optical system or the image pickup unit toward a center within a range where it is possible to move within a period in a case where the period when the control information instructs stop of the optical correction is shorter than a time required for pulling the optical system or the image pickup unit back to a center position.

(13)

A solid-state image pickup element including:

an image pickup unit configured to capture an image of an object via an optical system that collects light from the object; and

a logic unit configured to find a movement amount in a process of relatively moving at least one of the optical system and the image pickup unit and optically correcting blur appearing on an image captured by the image pickup unit on the basis of physically detected movement of the image pickup unit, perform a process of adding perpendicular plane direction position information in which a position of the optical system or the image pickup unit driven in a plane direction perpendicular to an optical axis direction under control by a drive control unit that controls drive of at least one of the optical system and the image pickup unit is detected, movement information representing physically detected movement of the image pickup unit, and optical axis direction position information indicating a relative position in an optical axis direction between the optical system and the image pickup unit to an image captured by the image pickup unit, and give an output to a signal processing unit that performs signal processing of correcting an influence of movement of the image pickup unit on the image according to a function that converts a position using the perpendicular plane direction position information, the movement information, and the optical axis direction position information synchronized for each coordinate on the image on the basis of the perpendicular plane direction position information, the movement information, and the optical axis direction position information.

(14)

A camera module including:

an optical system that collects light from an object;

an image pickup unit that captures an image of the object via the optical system;

a drive control unit configured to find a movement amount in a process of relatively moving at least one of the optical system and the image pickup unit and performing optical correction of blur appearing on an image captured by the image pickup unit on the basis of physically detected movement of the image pickup unit and control drive of at least one of the optical system and the image pickup unit; and

a logic unit configured to supply perpendicular plane direction position information, movement information, and optical axis direction position information, and timing information indicating timing that synchronizes the perpendicular plane direction position information, the movement information, and the optical axis direction position information with a coordinate on the image together with an image captured by the image pickup unit to a signal processing unit that performs signal processing of correcting an influence of movement of the image pickup unit on the image according to a function that converts a position using the perpendicular plane direction position information, the movement information, and the optical axis direction position information synchronized for each coordinate on the image on the basis of the perpendicular plane direction position information in which a position of the optical system or the image pickup unit driven in a plane direction perpendicular to an optical axis direction under control by the drive control unit is detected, the movement information representing physically detected movement of the image pickup unit, and the optical axis direction position information indicating a relative position in an optical axis direction between the optical system and the image pickup unit.

(15)

A drive control unit that

finds a movement amount in a process of relatively moving at least one of an optical system and an image pickup unit and optically correcting blur appearing on an image captured by the image pickup unit on the basis of physically detected movement of the image pickup unit that captures an image of the object via the optical system that collects light from the object, controls drive of at least one of the optical system and the image pickup unit,

performs a process of adding perpendicular plane direction position information in which a position of the optical system or the image pickup unit driven in a plane direction perpendicular to an optical axis direction under the control is detected, movement information representing physically detected movement of the image pickup unit, and optical axis direction position information indicating a relative position in an optical axis direction between the optical system and the image pickup unit to an image captured by the image pickup unit, and supplies the perpendicular plane direction position information, the movement information, and the optical axis direction position information to a logic unit configured to give an output to a signal processing unit that performs signal processing of correcting an influence of movement of the image pickup unit on the image according to a function that converts a position using the perpendicular plane direction position information, the movement information, and the optical axis direction position information synchronized for each coordinate on the image on the basis of the perpendicular plane direction position information, the movement information, and the optical axis direction position information.

(16)

An image pickup method performed by an image pickup device, the method including:

finding a movement amount in a process of relatively moving at least one of an optical system and an image pickup unit and optically correcting blur appearing on an image captured by the image pickup unit on the basis of physically detected movement of the image pickup unit that captures an object via the optical system that collects light from the object, and controlling drive of at least one of the optical system and the image pickup unit; and

performing signal processing of correcting an influence of movement of the image pickup unit on the image according to a function that converts a position using perpendicular plane direction position information, movement information, and optical axis direction position information synchronized for each coordinate on the image on the basis of the perpendicular plane direction position information in which a position of the optical system or the image pickup unit driven in a plane direction perpendicular to an optical axis direction under the control is detected, the movement information representing physically detected movement of the image pickup unit, and the optical axis direction position information indicating a relative position in an optical axis direction between the optical system and the image pickup unit.

(17)

The image pickup method according to (16), further including

performing a process of adding the perpendicular plane direction position information, the movement information, and the optical axis direction position information to an image captured by the image pickup unit together with timing information indicating a perpendicular position of the image that has been exposed at timing when the perpendicular plane direction position information, the movement information, and the optical axis direction position information have been acquired.

Note that the present embodiment is not limited to the embodiments described above, and various modifications can be made without departing from the gist of the present disclosure. Furthermore, the effects described herein are merely examples and not restrictive, and other effects may be obtained.

### REFERENCE SIGNS LIST

11 Image pickup device
12 Lens unit
13 Image sensor
14 Motion sensor
15 Optical system driver
16 Optical system actuator
17 Signal processing unit
18 Display
19 Recording medium
21 Image pickup unit
22 Logic unit

1. An image pickup device comprising:
an image pickup unit configured to capture an image of an object via an optical system that collects light from the object;
a drive control unit configured to find a movement amount in a process of relatively moving at least one of the optical system and the image pickup unit and performing optical correction of blur appearing on an image captured by the image pickup unit on a basis of physically detected movement of the image pickup unit and control drive of at least one of the optical system and the image pickup unit; and
a signal processing unit configured to perform signal processing of correcting an influence of movement of the image pickup unit on the image according to a function that converts a position using perpendicular plane direction position information, movement information, and optical axis direction position information synchronized for each coordinate on the image on a basis of the perpendicular plane direction position information in which a position of the optical system or the image pickup unit driven in a plane direction perpendicular to an optical axis direction under control by the drive control unit is detected, the movement information representing physically detected movement of the image pickup unit, and the optical axis direction position information indicating a relative position in an optical axis direction between the optical system and the image pickup unit.

2. The image pickup device according to claim 1,
wherein angular velocity information indicating angular velocity generated in the image pickup unit, and acceleration information indicating acceleration generated in the image pickup unit are used as the movement information.

3. The image pickup device according to claim 1,
wherein the optical axis direction position information is based on a distance between the optical system and the image pickup unit in a process of autofocusing the object under control by the drive control unit.

4. The image pickup device according to claim 1,
wherein the signal processing unit performs the signal processing on five axes or six axes of movement of the image pickup unit for each coordinate on the image.

5. The image pickup device according to claim 1, further comprising
a logic unit that supplies the perpendicular plane direction position information, the movement information, and the optical axis direction position information, and timing information indicating timing to synchronize the perpendicular plane direction position information, the movement information, and the optical axis direction position information with a coordinate on the image to the signal processing unit together with an image captured by the image pickup unit.

6. The image pickup device according to claim 5,
wherein the logic unit adds the perpendicular plane direction position information, the movement information, and the optical axis direction position information to the image together with the timing information and outputs information.

7. The image pickup device according to claim 5,
wherein the logic unit associates information indicating a perpendicular position of the image with the perpendicular plane direction position information, the movement information, and the optical axis direction position information in units of one line of the perpendicular position as the timing information and outputs information.

8. The image pickup device according to claim 5, further comprising
an image sensor configured by stacking the image pickup unit and the logic unit,
wherein the perpendicular plane direction position information, the movement information, the optical axis direction position information, and the timing information are supplied from the image sensor to the signal processing unit together with the image.

9. The image pickup device according to claim 1, further comprising
a drive unit configured to drive at least one of the optical system and the image pickup unit in a plane direction perpendicular to an optical axis direction according to the movement amount found by the drive control unit, detect a position of the optical system or the image pickup unit according to the drive, supply the perpendicular plane direction position information to the drive control unit, perform drive of displacing a distance between the optical system and the image pickup unit in an optical axis direction in a process of autofocusing the object under control by the drive control unit, detect a position of the optical system or the image pickup unit according to the drive, and supply the optical axis direction position information to the drive control unit.

10. The image pickup device according to claim 5, further comprising
a detection unit that physically detects movement of the image pickup unit and supplies the movement information to the drive control unit,
wherein the perpendicular plane direction position information, the movement information, and the optical axis direction position information are supplied from the drive control unit to the logic unit.

11. The image pickup device according to claim 5,
wherein the logic unit generates control information instructing execution or stop of the optical correction according to exposure timing at which the image pickup unit performs exposure, and supplies the control information to the drive control unit, and
the drive control unit controls drive of at least one of the optical system and the image pickup unit on a basis of the control information during a period when the optical correction is being executed so as to perform optical correction of blur appearing on an image captured by the image pickup unit and pull the optical system or the image pickup unit back to a center position while the optical correction is being stopped.

12. The image pickup device according to claim 11,
wherein the drive control unit controls drive so as to move the optical system or the image pickup unit toward a center within a range where it is possible to move within a period in a case where the period when the control information instructs stop of the optical correction is shorter than a time required for pulling the optical system or the image pickup unit back to a center position.

13. A solid-state image pickup element comprising:
an image pickup unit configured to capture an image of an object via an optical system that collects light from the object; and
a logic unit configured to find a movement amount in a process of relatively moving at least one of the optical system and the image pickup unit and optically correcting blur appearing on an image captured by the image pickup unit on a basis of physically detected movement of the image pickup unit, perform a process of adding perpendicular plane direction position information in which a position of the optical system or the image pickup unit driven in a plane direction perpendicular to an optical axis direction under control by a drive control unit that controls drive of at least one of the optical system and the image pickup unit is detected, movement information representing physically detected movement of the image pickup unit, and optical axis direction position information indicating a relative position in an optical axis direction between the optical system and the image pickup unit to an image captured by the image pickup unit, and give an output to a signal processing unit that performs signal processing of correcting an influence of movement of the image pickup unit on the image according to a function that converts a position using the perpendicular plane direction position information, the movement information, and the optical axis direction position information synchronized for each coordinate on the image on a basis of the perpendicular plane direction position information, the movement information, and the optical axis direction position information.

14. A camera module comprising:
an optical system that collects light from an object;
an image pickup unit that captures an image of the object via the optical system;
a drive control unit configured to find a movement amount in a process of relatively moving at least one of the optical system and the image pickup unit and performing optical correction of blur appearing on an image captured by the image pickup unit on a basis of physically detected movement of the image pickup unit and control drive of at least one of the optical system and the image pickup unit; and
a logic unit configured to supply perpendicular plane direction position information, movement information, and optical axis direction position information, and timing information indicating timing that synchronizes the perpendicular plane direction position information, the movement information, and the optical axis direction position information with a coordinate on the image together with an image captured by the image pickup unit to a signal processing unit that performs signal processing of correcting an influence of movement of the image pickup unit on the image according to a function that converts a position using the perpendicular plane direction position information, the movement information, and the optical axis direction position information synchronized for each coordinate on the image on a basis of the perpendicular plane direction position information in which a position of the optical system or the image pickup unit driven in a plane direction perpendicular to an optical axis direction under control by the drive control unit is detected, the movement information representing physically detected movement of the image pickup unit, and the optical axis direction position information indicating a relative position in an optical axis direction between the optical system and the image pickup unit.

15. A drive control unit that
finds a movement amount in a process of relatively moving at least one of an optical system and an image pickup unit and optically correcting blur appearing on an image captured by the image pickup unit on a basis of physically detected movement of the image pickup unit that captures an image of the object via the optical system that collects light from the object, controls drive of at least one of the optical system and the image pickup unit,
performs a process of adding perpendicular plane direction position information in which a position of the optical system or the image pickup unit driven in a plane direction perpendicular to an optical axis direction under the control is detected, movement information representing physically detected movement of the image pickup unit, and optical axis direction position information indicating a relative position in an optical axis direction between the optical system and the image pickup unit to an image captured by the image pickup unit, and supplies the perpendicular plane direction position information, the movement information, and the optical axis direction position information to a logic unit configured to give an output to a signal processing unit that performs signal processing of correcting an influence of movement of the image pickup unit on the image according to a function that converts a position using the perpendicular plane direction position information, the movement information, and the optical axis direction position information synchronized for each coordinate on the image on a basis of the perpendicular plane direction position information, the movement information, and the optical axis direction position information.

16. An image pickup method performed by an image pickup device, the method comprising:
finding a movement amount in a process of relatively moving at least one of an optical system and an image pickup unit and optically correcting blur appearing on an image captured by the image pickup unit on a basis of physically detected movement of the image pickup unit that captures an object via the optical system that collects light from the object, and controlling drive of at least one of the optical system and the image pickup unit; and
performing signal processing of correcting an influence of movement of the image pickup unit on the image according to a function that converts a position using perpendicular plane direction position information, movement information, and optical axis direction position information synchronized for each coordinate on the image on a basis of the perpendicular plane direction position information in which a position of the optical system or the image pickup unit driven in a plane direction perpendicular to an optical axis direction under the control is detected, the movement information representing physically detected movement of the image pickup unit, and the optical axis direction position information indicating a relative position in an optical axis direction between the optical system and the image pickup unit.

17. The image pickup method according to claim 16, further comprising
performing a process of adding the perpendicular plane direction position information, the movement information, and the optical axis direction position information to an image captured by the image pickup unit together with timing information indicating a perpendicular position of the image that has been exposed at timing when the perpendicular plane direction position information, the movement information, and the optical axis direction position information have been acquired.
